(19) United States
(12) Patent Application Publication
(10) Pub. No.: US 2008/0043180 A1
(43) Pub. Date: Feb. 21, 2008

(54) Color filter and liquid display device provided with color filter

(75) Inventors: Hidesato Hagiwara, Tokyo (JP); Takeshi Itoi, Tokyo (JP); Takumi Saito, Tokyo (JP); Hiromitsu Ito, Tokyo (JP)

Correspondence Address: STAAS & HALSEY LLP, SUITE 700, 1201 NEW YORK AVENUE, N.W., WASHINGTON, DC, 20005, US

(73) Assignee: TOPPAN PRINTING CO., LTD., Tokyo (JP)

(21) Appl. No.: 11/783,052

(22) Filed: Apr. 5, 2007

Related U.S. Application Data
(63) Continuation of application No. PCT/JP05/18664, filed on Oct. 7, 2005.

(30) Foreign Application Priority Data
Oct. 12, 2004 (JP) 2004-297292

(51) Int. Cl. G02F 1/1335

(52) U.S. Cl. 349/106

(57) ABSTRACT

A color filter adapted to be employed in an in-plane switching mode liquid crystal display device, which is incorporated in the liquid crystal device without interposing electrodes between a liquid crystal and pixels, and which includes a transparent substrate, and pixels having color layers representing a plurality of colors and formed on the transparent substrate, wherein a protective layer is not formed on the pixels, and a dielectric loss tangent (tan δ) of at least one color layer is confined to not higher than 0.03 at a frequency ranging from 10 Hz to 100 Hz.

### CROSS REFERENCE TO RELATED APPLICATIONS

This is a Continuation Application of PCT Application No. PCT/JP2005/018664, filed Oct. 7, 2005, which was published under PCT Article 21(2) in Japanese.

This application is based upon and claims the benefit of priority from prior Japanese Patent Application No. 2004-297292, filed Oct. 12, 2004, the entire contents of which are incorporated herein by reference.

### BACKGROUND OF THE INVENTION

1. Field of the Invention

This invention relates to a color filter to be employed in an in-plane switching mode liquid crystal device and to an in-plane switching mode liquid crystal device which is provided with the color filter. In particular, this invention relates to a color filter in which the electrical properties of color layers constituting pixels do not badly affect the switching performance of the liquid crystal and it is possible to secure high reliability without necessitating the provision of a protective layer on the pixels, and to an in-plane switching mode liquid crystal device which is provided with such a color filter.

2. Description of the Related Art

A color liquid crystal display device is now being rapidly promoted especially as a computer terminal display device or as a television image display device. A color filter is an indispensable important component for enabling a liquid crystal display device to exhibit color images. In recent years, there has been a strong demand for the enhancement in quality of images to be displayed in the color liquid crystal display device. With a view to meet the demand, there have been developed various kinds of liquid crystal display devices of new type which are wide in viewing angle or high in speed of response. Among them, a liquid crystal display device of an in-plane switching (IPS) mode is expected to be widely propagated in near future since the liquid crystal display device of this system is excellent in display qualities such as viewing angle, contrast ratio, etc.

In contrast to the liquid crystal display devices of other systems such as a twisted nematic (TN) system and vertical alignment (VA) system, however, the in-plane switching mode liquid crystal display device is accompanied with a problem that, due to the absence of electrodes between pixels and liquid crystal and, hence due to the presence of color layer of color filter in the driving electric field of liquid crystal, the liquid crystal molecule will be directly influenced by the electric properties of the material of the color layer.

As a matter of fact, when conventional materials for the color layer are employed for creating the color filter for the in-plane switching mode liquid crystal display device, various display failures such as the disturbance in orientation of liquid crystal due to the electric properties of the material for the color layer and the image persistence due to the deviation of threshold value of switching would be caused to occur.

The electric properties of this material for the color layer can be mainly ascribed to the nature of pigment contained as a colorant in the color layer, so that it is difficult to fundamentally overcome this problem. Therefore, if a color filter formed of a conventional color material is to be employed in an in-plane switching mode liquid crystal display device, it is generally practiced to form a protective layer (overcoat layer) made of a transparent resin on the pixels, thus preventing the color layer from being directly contacted with a liquid crystal.

However, there is an increasing trend in recent years to lower the price of liquid crystal display device, so that a color filter to be employed as a component for the liquid crystal display device is also required to have the manufacturing cost thereof lowered. As described above, it may be also possible, through the provision of an overcoat layer made of transparent resin on the pixels, to incorporate such a color filter into an in-plane switching mode liquid crystal display device a even if a conventional material is employed for the color layer of pixels. Even in that case however, various forms of display failure may be caused to generate (see for example, JP Patent Laid-open Publication (Kokai) No. 2004-117537 (2004).

Further, although improvements have been made in the materials for the color layer and in the materials for the overcoat layer so as to conform them with an in-plane switching mode liquid crystal display device, it may be required, in order to secure a satisfactory performance of the display device, to form a thick overcoat layer having a thickness of not less than 2 μm under some circumstances, thus raising a problem that it is difficult to uniformly coat the overcoat layer, which is one of the reasons for preventing the reduction of manufacturing cost.

Furthermore, an increase of material cost as well as a reduction of yield due to an increase in number of manufacturing steps is also a factor for preventing the reduction of manufacturing cost. Although it is desired to develop a color filter which is capable of being applied it to an in-plane switching mode liquid crystal display device without necessitating the provision of the overcoat layer, it has been difficult to realize such a color filter due to the aforementioned problems.

### BRIEF SUMMARY OF THE INVENTION

Problems to be Solved by the Invention:

The present invention has been made in view of overcoming the problems mentioned above and hence an object of the present invention is to provide a color filter which is adapted to be employed in an in-plane switching mode liquid crystal display device and is capable of securing high reliability without necessitating the provision of a protective layer (overcoat layer) formed of a transparent resin and without any possibility of having a bad influence on the switching performance of liquid crystal due to the electrical nature of the color layer constituting the pixels.

Another object of the present invention is to provide an in-plane switching mode liquid crystal display device which is provided with the aforementioned color filter.

Means for Solving the Problem:

According to a first aspect of the present invention, there is provided a color filter adapted to be employed in an in-plane switching mode liquid crystal display device, which is incorporated in the liquid crystal display device without interposing electrodes between a liquid crystal and pixels, and which comprises a transparent substrate, and pixels including color layers representing a plurality of colors and formed on the transparent substrate, wherein a protective layer is not formed on the pixels, and a dielectric loss tangent (tan δ) of at least one color layer is confined to not higher than 0.03 at a frequency ranging from 10 Hz to 100 Hz.

According to a second aspect of the present invention, there is provided a color filter which is adapted to be employed in an in-plane switching mode liquid crystal display device, which comprises a transparent substrate, and pixels including color layers representing a plurality of colors and formed on the transparent substrate, wherein a difference in dielectric loss tangent (tan δ) between at least one color layer and a liquid crystal material of the liquid crystal display device is confined to not higher than 0.03 at a frequency ranging from 10 Hz to 100 Hz.

According to a third aspect of the present invention, there is provided an in-plane switching mode liquid crystal display device which is provided with any one of the aforementioned color filters.

### BRIEF DESCRIPTION OF THE SEVERAL VIEWS OF THE DRAWING

FIG. 1 is a schematic cross-sectional view of the in-plane switching mode liquid crystal display device;

FIG. 2 is a graph showing frequency characteristics of dielectric loss tangent of materials of red color layer;

FIG. 3 is a graph showing frequency characteristics of dielectric loss tangent of materials of green color layer;

FIG. 4 is a graph showing frequency characteristics of dielectric loss tangent of materials of blue color layer; and

FIG. 5 is a graph showing a relationship between the concentration of green pigment and the dielectric loss tangent of materials of green color layer.

### DETAILED DESCRIPTION OF THE INVENTION

The color filter according to a first aspect of the present invention is adapted to be employed in an in-plane switching mode liquid crystal display device and comprises a transparent substrate, pixels including color layers representing a plurality of colors and formed on the transparent substrate, and a liquid crystal alignment film which is formed on the pixels without interposing a protective film therebetween; wherein a dielectric loss tangent (tan δ) of at least one color layer of the color layers is confined to not higher than 0.03 at a frequency ranging from 10 Hz to 100 Hz.

The color filter thus constructed is free from disturbance in orientation of liquid crystal or from deviation of threshold value of switching without a protective layer (overcoat layer) on the occasion when the color filter is employed in an in-plane switching mode liquid crystal display device. Thus, the color filter would not badly affect the display performance of the liquid crystal display device.

The color filter according to a first aspect of the present invention can be advantageously employed on the occasion where the pixels comprise a green color layer, i.e., the aforementioned plurality of colors are constituted by R, G and B. In this case, the dielectric loss tangent (tan δ) of green color layer may preferably be confined to not higher than 0.03 at a frequency ranging from 10 Hz to 100 Hz. Further, the pixels may comprise a red color layer and a blue color layer wherein the dielectric loss tangent (tan δ) thereof is confined to not higher than 0.03 at a frequency ranging from 10 Hz to 100 Hz.

The green color layer may preferably have a relative dielectric constant of not higher than 5.0 at a frequency ranging from 10 Hz to 100 Hz. Namely, when it is assumed that the pixels are formed of three color layers, i.e. red, green and blue (R, G, B) color layers, it would be effective, in order to obtain a liquid crystal display device excellent in display performance, to confine the relative dielectric constant of the green color layer which is liable to become large in value of dielectric loss tangent because of the nature of the color pigment to not higher than 5.0 at a frequency ranging from 10 Hz to 100 Hz.

The color filter according to a first aspect of the present invention may preferably be constructed such that the surface step height thereof is limited to not more than 0.3 μm. If the surface step height of the color filter is confined to not more than 0.3 μm, it is possible to prevent the generation of disturbance in orientation of liquid crystal molecule, thus contributing the enhancement of liquid crystal display performance.

The color filter according to a first aspect of the present invention may preferably be constructed such that the contact angle thereof to the surface water is limited to not more than 65°. When the contact angle of the color filter to the surface water is limited to not more than 65°, the affinity of the color filter to a polyimide alignment film to be deposited thinly on the color filter would become more excellent, thus enabling the polyimide alignment film to be formed uniformly. As a result, the orientation of liquid crystal molecule would become uniform, thus contributing to the enhancement of liquid crystal display characteristics.

Incidentally, each of the color layers representing a plurality of colors may contain a surfactant in order to improve the coating properties of coating liquid to the substrate. However, in order to confine the contact angle of the color filter to the water to not more than 65°, the content of the surfactant may preferably be confined to not too large, i.e. to the range of 0.001 to 0.2% by weight based on the weight of the coating material for forming color layers.

The green color layer may preferably contain a green pigment at a ratio of not more than 30% by weight based on the weight of entire solid matters. When the content of the pigment is confined to not more than 30% by weight based on the weight of entire solid matters, the dielectric loss tangent (tan δ) of the green color layer can be controlled to 0.03 or less at a frequency ranging from 10 Hz to 100 Hz.

Further, the green color layer may preferably contain a green pigment where the quantity of elution of alkali metal ions such as Na⁺ and K⁺, and of halogen ions such as Cl⁻, Br⁻ is respectively limited to not higher than 2 ppm in a 3-hour elution test in pure water. When the quantity of elution of ions of the green pigment is limited to 2 ppm or less in every cases, the dielectric loss tangent (tan δ) of the green color layer can be controlled to 0.03 or less at a frequency ranging from 10 Hz to 100 Hz.

The color filter according to a second aspect of the present invention is useful in the fabrication of an in-plane switching mode liquid crystal display device and comprises a transparent substrate, and pixels comprising color layers representing a plurality of colors and formed on the transparent substrate; wherein a difference in dielectric loss tangent (tan δ) between at least one color layer of the color layers and a liquid crystal material of the liquid crystal display device is confined to not higher than 0.03 at a frequency ranging from 10 Hz to 100 Hz.

It is possible, through the minimization of the difference in dielectric loss tangent (tan δ) between the color layer and a liquid crystal material, to realize excellent display performance of the display device.

The liquid crystal display device according to a third aspect of the present invention is featured as being equipped with any of the aforementioned color filters. According to this liquid crystal display device, it is possible to realize excellent display performance of the display device due to the provision of these color filters.

Next, the color filter according to one embodiment of the present invention will be explained in detail.

The color filter according to one embodiment of the present invention is provided with pixels comprising a plurality of color layers differing in color and formed on the surface of transparent substrate. These color layers may be formed of a combination of red, green and blue (RGB) or a combination of yellow, magenta and cyan (YMC). The color filter according to one embodiment of the present invention can be especially advantageously applied to a color filter comprising a green color layer (i.e. RGB system).

As a result of studies on the relationship between the electric nature of color filter and the display failure of the in-plane switching mode liquid crystal display device, it has been found out by the present inventors that the generation of defective orientation of liquid crystal or deviation in threshold value of switching in an in-plane switching mode liquid crystal display device can be mainly ascribed to the dielectric characteristics of the materials of color layers. This phenomenon can be specifically explained by making use of the values of dielectric loss tangent. Namely, this phenomenon is assumed to occur generally due to the following mechanism.

The dielectric loss tangent (tan δ) is a ratio between the quantity of electric charge accumulated in a dielectric material quantity of electric charge that has been consumed. When the dielectric loss tangent is relatively small, the electric charge accumulated in the dielectric material can be retained. Whereas, when the dielectric loss tangent is relatively large, the electric charge is consumed and hence cannot be retained.

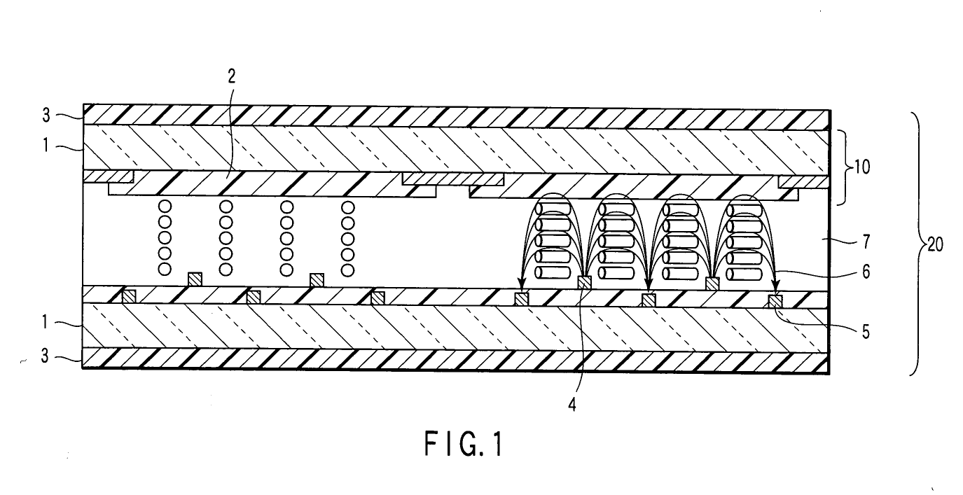

FIG. 1 shows a schematic cross-sectional view of an in-plane switching mode liquid crystal display device. This liquid crystal display device of in-plane switching mode 20 is constructed such that it comprises a color filter 10 having color layers 2 formed on a transparent substrate 1a, and a liquid crystal layer 7 sandwiched between the transparent substrate 1a and a transparent substrate 1b, and that pixel electrodes 4 and common electrodes 5 are both arranged on the transparent substrate 1b side. Incidentally, on the outer surfaces of these transparent substrates 1a and 1b, there are disposed polarizing plates 3a and 3b.

In the in-plane switching mode liquid crystal display device shown in FIG. 1, the color layers 2 constituting the pixels of the color filter 10 are disposed between a pair of substrates 1 in a manner to face inward, thus positioning the color layers 2 in the liquid crystal driving electric field 6. Therefore, in this liquid crystal display device of in-plane switching mode, when a difference in dielectric loss tangent value between the color layers 2 and the other members (liquid crystal, alignment film, etc.,) inside the cell is increased, a phenomenon to make non-uniform the retention state of electric charge of liquid crystal molecule will be caused to generate.

When the retention state of electric charge becomes non-uniform, an electric field of vertical direction, which is undesirable, is caused to generate in the in-plane switching mode liquid crystal display device, thereby giving rise to the generation of defective orientation of liquid crystal or the generation of deviation of threshold value due to redundant residue of electric charge. As a result, defective display such as seize of picture images is caused to generate. Therefore, the dielectric loss tangent of the material of color layers 2 constituting the pixels of color filter 10 is an important characteristic which determines the display characteristics of the in-plane switching mode liquid crystal display device. Although the value of dielectric loss tangent depends on the measuring frequency, since one frame of driving liquid crystal is about 60 Hz, it would be appropriate to take notice of the value of dielectric loss tangent at around 30 Hz in cycle (seconds) or frequency, or at a frequency of nearly 10-100 Hz.

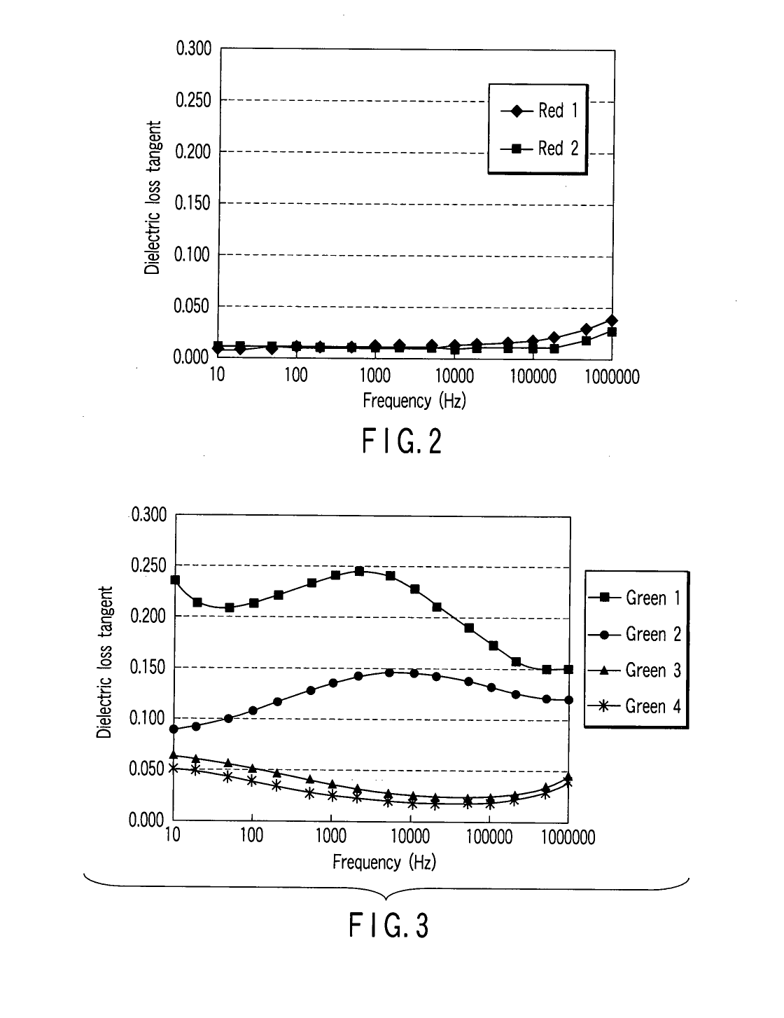

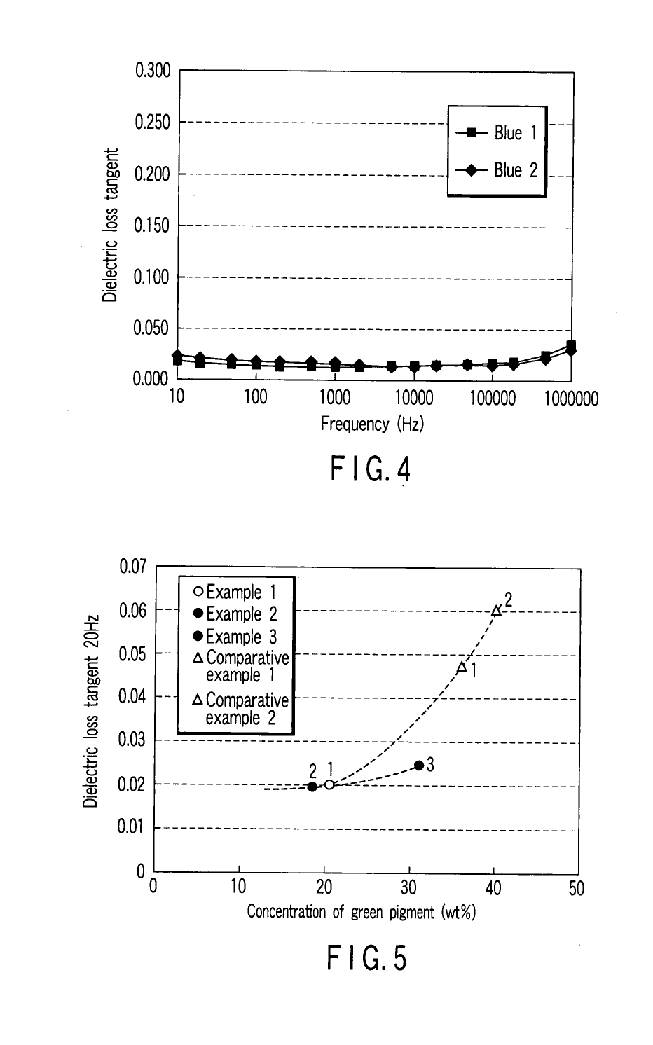

FIGS. 2, 3 and 4 illustrate the results measured of the dielectric loss tangent of several kinds of the materials of color layers which have been employed in the conventional color filters. The dielectric loss tangent of color layer of each color constituting the pixels of the conventional color filters falls within the range of about 0.006 to 0.2 at a frequency of 10 Hz-100 Hz, though it varies depending on the kinds of materials of color layers. As shown in FIG. 3, there are many kinds of materials which are high in dielectric loss tangent particularly in the case of materials for green color layer. As a matter of fact, at least in the case of green color layer, there have been much possibilities of generating defective alignment of pixels or deviation of threshold value unless an overcoat layer is provided at a boundary between the color layer and a liquid crystal holding plane.

The present inventors have made extensive studies on the improvement of this characteristic dielectric property with a view to provide a color filter which is capable of overcoming the deviation of threshold value of pixels and the defective alignment and capable of enhancing the display quality without necessitating the provision of an overcoat layer at a boundary between the pixels and a liquid crystal holding plane in the color filter to be employed in a liquid crystal display device, in particular, in a liquid crystal display device of in-plane switching mode where electrodes are not interposed between the pixels and the liquid crystal.

Generally, the materials for liquid crystal or for alignment film are excellent in capacity of holding electric charge. Namely, the materials for liquid crystal or for alignment film are relatively small in dielectric loss tangent and the values thereof are generally 0.005 to 0.02 or so. Therefore, it is considered preferable that the value of dielectric loss tangent of the materials for the color layers provided in the color filter to be employed in a liquid crystal display device of in-plane switching mode may be almost the same as the value of dielectric loss tangent of the materials for liquid crystal or for alignment film.

Namely, it has been found out by the present inventors that when the dielectric loss tangent of the color layers constituting the pixels of color filter is confined to not more than 0.03, more preferably not more than 0.02 at a frequency of 10 Hz to 100 Hz, it is possible to effectively prevent the deterioration of display quality such as defective alignment of pixels or deviation of threshold value without the overcoat layer on the pixels. Although the dielectric loss tangent of the color layers may be as low as possible, the lower limit of the dielectric loss tangent would be around 0.005-0.006 at present when the properties of materials for the color layers are taken into account.

Further, it has been found out as a result of extensive studies made by the present inventors that in the case of the color filter according to one embodiment of the present invention, the relative dielectric constant of the color layers may preferably be confined to not more than 5.0, more preferably not more than 0.02 at a frequency of 10 Hz to 100 Hz. This relative dielectric constant is an indication of the quantity of electric charge to be accumulated in a dielectric body, so that when the value of relative dielectric constant of color layers become very large, the balance in quantity of electric charge to be accumulated between the color layers and the members (liquid crystal, alignment film, etc.,) in the cell would be badly deteriorated, thus giving rise to the generation of defective display such as the seize of picture image due to the deviation of threshold value. Therefore, the relative dielectric constant of the color layers constituting the pixels of color filter may preferably be confined to not more than 5.0, more preferably not more than 4.5 at a frequency of 10 Hz to 100 Hz. Although the relative dielectric constant of the color layers may be as low as possible, the lower limit of the relative dielectric constant would be around 3.0 at present when the properties of materials for the color layers are taken into account.

As for the effective means for realizing these characteristics, the concentration of green pigment which is relatively high in dielectric loss tangent may be limited to a predetermined value, i.e. not more than 30% by weight based on the solid matters of the color layers of color filter.

Further, the enhancement of purity of pigment would be effective in minimizing the dielectric loss tangent-of the pigment itself. As for the means for determining the purity of pigment, there is an ion elution test wherein a pigment is boiled in pure water for three hours to determine the quantity of elution of alkali metal ions such as Na⁺, K⁺, etc., and halogen element ions such as Cl⁻, Br⁻, etc. The upper limit in quantity of elution of ions for confining the dielectric loss tangent to not more than 0.03 at a frequency of 10 Hz to 100 Hz would be, in every case, at most 2 ppm based on the weight of pigment. Therefore, the color layers may preferably be formed by making use of pigments where the quantity of elution of these ions (purity) is confined to as described above.

The employment of a resin material which is low in dielectric loss tangent is also effective as another means for obtaining color layers where the dielectric loss tangent can be confined to not more than 0.03 at a frequency of 10 Hz to 100 Hz.

The surface of the color layers of color filter may preferably be flat in order to prevent the orientation of liquid crystal molecule from being disturbed. In the case of the present invention, since a transparent protective layer is not provided on the surface of color layers and hence the color layers are permitted to contact with the liquid crystal with a very thin polyimide alignment film being interposed therebetween, the flatness of the surface of color layers is much more important. Therefore, the surface step height of the color filter may preferably be limited to not more than 0.3 μm.

Incidentally, in the case of the color filter in recent years, a light-shielding layer having a lattice pattern, i.e. a black matrix layer is deposited at first on the surface of a glass transparent substrate and then color layers of various colors are respectively formed on the glass transparent substrate. This light-shielding film however has a thickness ranging from 1.0 to 1.5 μm or so in the case where the light-shielding film is formed of a resinous black matrix comprising, as main components, a resin and a black pigment. On the other hand, since the thickness of the color layers is as thick as 1.0 to 3.0 μm, the superimposed portions of the light-shielding film with the color layers would become a projected portion having a fairly large height.

As for the means for flattening the color layers, it may be advisable to design the material of color layer so as to have a gently inclined peripheral portion, thereby making it possible to suppress the projection of the color layers at the superimposed portion between the resin black matrix layer and the color layers. To enlarge the thickness of the color layers relative to the thickness of the resin black matrix layer is also effective in suppressing the projection. Alternatively, means to minimize, as much as possible, the superimposed portion between the resin black matrix layer and the color layers is also effective in suppressing the projection. Further, it is also possible to eliminate the projection by polishing the surface of the color layers or by erasing the projection after the formation of the color layers. As for the polishing means, it is possible to employ mechanical polishing by making use of a plane polishing machine or an oscar type polishing machine.

On the occasion of incorporating the color filter in a liquid crystal display device, a thin film of alignment film for orientating the liquid crystal is formed on the surface of the color filter. As for the formation of the alignment film, mainly polyimide resin can be employed wherein polyimide resin or a precursor thereof is dissolved in a suitable solvent to obtain a solution, which is then coated on the surface of the color filter by means of screen printing or flexographic printing in general and then dried and thermally cured to form the alignment film.

As for the solvent for dissolving the polyimide resin or a precursor thereof, it is possible to employ NMP (N-methyl-2-pyrolidinone) or γ-butyrolactone in general. If the wettability of the surface of color filter to these solvents is not sufficient, a region where the alignment film is not partially or entirely formed thereon is caused to generate on the occasion of coating a coating solution for alignment film on the surface of color filter, thereby giving rise to the generation of defective liquid crystal display.

Generally, when a transparent protective layer is deposited on the color filter for the preparation of a liquid crystal display device of in-plane switching mode, it may be possible to secure the wettability to solvent by the presence of the transparent protective layer. However, since such a transparent protective layer is omitted in the present invention, it may be impossible to expect such an effect. Accordingly, it is required to provide the color layer of color filter with a satisfactory wettability to the solvent.

For this purpose, the contact angle of the surface of color layers to water may preferably be made 65° or less, thus securing the satisfactory wettability of the surface of color layers to the solvent for polyimide. The aforementioned contact angle may more preferably be controlled to 55° or less, most preferably 45° or less. The contact angle of the surface of color layers to water can be made 65° or less by subjecting a color filter to ultraviolet irradiation treatment in the presence of oxygen. Alternatively, the contact angle of the surface of color layers to water can be made 65° or less by reducing the mixing ratio of a surfactant on the occasion of incorporating the surfactant to a coating material for forming the color layers, which is generally performed for securing a suitable coating property of the coating material. Specifically, the mixing ratio of the surfactant to the coating material for forming the color layers may preferably be confined to the range of 0.001 to 0.2% weight, more preferably the range of 0.005 to 0.1% weight. Explanations with respect to the kinds of the surfactant will be set forth hereinafter.

Next, the method of manufacturing a color filter according to one embodiment of the present invention will be explained as follows.

The color filter according to one embodiment of the present invention comprises pixels formed of color layers differing in color and formed on the surface of transparent substrate. These colors may include a combination of red, green and blue (RGB) or a combination of yellow, magenta and cyan (YMC). The color filter according to the present invention can be especially advantageously applied to a color filter comprising a green color layer (i.e. RGB system).

In the color filter according to one embodiment of the present invention, the color filter is incorporated in a liquid crystal display device with the surface of pixels being directed to the liquid crystal side. If desired, an alignment film may be deposited on the pixels. In the case of the color filter according to one embodiment of the present invention, since the driving electric field of liquid crystal is not badly affected by the influence of electric properties of color layers, an overcoat layer for covering the color layers is no longer required to be formed, thus making it possible to increase the yield and to reduce the manufacturing cost. Further, since a distance between the liquid crystal and the pixels can be shortened, the viewing angle can be enhanced, thus making it possible to provide a liquid crystal display device excellent in fineness.

As explained above, in the case of the color filter according to one embodiment of the present invention, it is not required to deposit an overcoat layer on the surface of pixels for supplementing the electric properties of color layers. However, a resin layer may be deposited for the purpose of flattening the color filter or for other purposes excluding the purpose of supplementing the electric properties of color layers. In this case, the thickness of the resin layer may not be so thick as that of the conventional overcoat layer.

The transparent substrate to be employed in the color filter according to one embodiment of the present invention may preferably have some degree of transmittance to visible light, more preferably a transmittance of 80% or more. The transparent substrate may be selected from those to be generally employed in a liquid crystal display device. For example, the transparent substrate may be a plastic substrate such as PET substrate, or a glass substrate. Generally, a glass substrate will be employed as a transparent substrate. If a light-shielding pattern is to be employed, it is possible to employ a pattern made of metal thin film such as chromium or made of a light-shielding resin and formed in advance on a transparent substrate by a conventional method.

The method of forming pixels on a transparent substrate may be optionally selected from the conventional methods such as an inkjet method, a printing method, a photolithography method, and an etching method. However, in view of enhanced fineness, controllability of spectral property and reproducibility, a photolithography method may be preferably employed-as follows. Namely, a pigment is dispersed in a suitable solvent together with a photo-initiator and a polymerizable monomer and incorporated in a transparent resin to prepare a photosensitive color composition. This photosensitive color composition is then coated on a transparent substrate to form a layer of photosensitive color composition, which is then subjected to patterning exposure and developing treatment to form a color layer of single color. This sequence of steps is repeated for each color to prepare a color filter provided with pixels formed of a plurality of color layers differing in color.

Next, the method of forming pixels by means of photolithography will be explained.

First of all, a pigment to be employed as a colorant is dispersed in a suitable solvent together with a photo-initiator and a polymerizable monomer and incorporated in a transparent resin to prepare a photosensitive color composition. As for the method of dispersing these components, there is not any particular limitation and hence, it is possible to employ various methods such as a mill base, a three-roll mill, a jet mill, etc.

Specific examples of organic pigments which can be employed as a colorant in the photosensitive color composition will be exemplified by way of the color index number thereof.

For the manufacture of a red color composition for forming a red filter segment, it is possible to employ red pigments such as C.I. Pigment Red 7, 9, 14, 41, 48:1, 48:2, 48:3, 48:4, 81:1, 81:2, 81:3, 97, 122, 123, 146, 149, 168, 177, 178, 180, 184, 185, 187, 192, 200, 202, 208, 210, 215, 216, 217, 220, 223, 224, 226, 227, 228, 240, 254, 255, 264, 272, 279, etc. This red color composition may include a yellow pigment or an orange color pigment.

As for yellow pigments, it is possible to employ C.I. Pigment Yellow 1, 2, 3, 4, 5, 6, 10, 12, 14, 15, 16, 17, 18, 20, 24, 31, 32, 34, 35, 35:1, 36, 36:1, 37, 37:1, 40, 42, 43, 53, 55, 60, 61, 62, 63, 65, 73, 74, 77, 81, 83, 86, 93, 94, 95, 97, 98, 100, 101, 104, 106, 108, 109, 110, 113, 114, 115, 116, 117, 118, 119, 120, 123, 125, 126, 127, 128, 129, 137, 138, 139, 144, 146, 147, 148, 150, 151, 152, 153, 154, 155, 156, 161, 162m, 164, 166, 167, 168, 169, 170, 171, 172, 173, 174, 175, 176, 177, 179, 180, 181, 182, 185, 187, 188, 193, 194, 199, 213, 214, etc. As for orange color pigment, it is possible to employ C.I. Pigment Orange 36, 43, 51, 55, 61, 71, 73, etc.

For the manufacture of a green color composition for forming a green filter segment, it is possible to employ green pigments such as C.I. Pigment Green 7, 10, 36, 37, etc. This green color composition may include a yellow pigment as in the case of the red color composition.

For the manufacture of a blue color composition for forming a blue filter segment, it is possible to employ blue pigments such as C.I. Pigment Blue 15, 15:1, 15:2, 15:3, 15:4, 15:6, 16, 22, 60, 64, 80, etc., more preferable blue pigment being C.I. Pigment Blue 15:6. Further, this blue color composition may include a purple pigment such as C.I. Pigment Violet 1, 19, 23, 27, 29, 30, 32, 37, 40, 42, 50, etc., more preferable purple pigment being C.I. Pigment Violet 23.

Further, in order to secure the excellent coating property, sensitivity and developing property of the color composition while keeping a balance between the chroma and brilliance, the organic pigments described above may be used in combination with an inorganic pigment. As for the inorganic pigment, it is possible to employ metal oxide powder, metal sulfide powder, metal powder such as yellow lead, zinc chrome, red iron oxide (III), cadmium red, ultramarine blue, cobalt green, etc. Further, in order to secure toning, dyes may be incorporated in the color composition within a ratio which would not deteriorate the heat resistance of the color filter.

The transparent resin which can be employed in the color composition may preferably have a permeability of not less than 80%, more preferably not less than 95% in a total wavelength range of 400-700 nm of visible light zone. As for the transparent resin, it is possible to employ thermoplastic resin, thermosetting resin and photosensitive resin. As required, the transparent resin may be formulated by making use of a precursor thereof, i.e., a monomer or an oligomer which is capable of creating a transparent resin through the curing thereof by the irradiation of radiation. In this case, the monomer or the oligomer may be employed singly or in combination of two or more kinds thereof.

As for the thermoplastic resin, it is possible to employ, for example, butyral resin, styrene-maleic acid copolymer, chlorinated polyethylene, chlorinated polypropylene, polyvinyl chloride, vinyl chloride-vinyl acetate copolymer, polyvinyl acetate, polyurethane resin, polyester resin, acrylic resin, alkyd resin, polystyrene, polybutadiene, polyimide, etc. As for the thermosetting resin, it is possible to employ epoxy resin, benzoguanamine resin, rosin-modified maleic resin, rosin-modified fumaric acid resin, melamine resin, urea resin, phenol resin, etc.

As for the photosensitive resin, it is possible to employ resins having a linear macromolecule into which a photo-curable group such as (metha)acryloyl group, styryl group, etc., has been introduced through a reaction between a linear macromolecule having a reactive substituent group such as hydroxyl group, carboxyl group, amino group, etc., and a (metha)acrylic compound having a reactive substituent group such as isocyanate group, aldehyde group, epoxy group, etc., or cinnamic acid. It is also possible to employ a linear macromolecule containing an acid anhydride such as styrene-maleic anhydride copolymer or α-olefin-maleic anhydride copolymer and half-esterified with a (metha)acrylic compound having hydroxyl group such as hydroxyalkyl(metha)acrylate.

As for the polymerizable monomers and oligomers that can be employed in this case, they include various kinds of acrylic esters and methacrylic esters such as methyl(metha)acrylate, ethyl(metha)acrylate, 2-hydroxyethyl(metha)acrylate, 2-hydroxypropyl(metha)acrylate, cyclohexyl(metha)acrylate, β-carboxyethyl(metha)acrylate, diethyleneglycol di(metha)acrylate, 1,6-hexanediol di(metha)acrylate, triethyleneglycol di(metha)acrylate, tripropyleneglycol di(metha)acrylate, trimethyrolpropane tri(metha)acrylate, pentaerythritol tri(metha)acrylate, 1,6-hexanediol diglycidyl ether di(metha)acrylate, bisphenol A diglycidyl ether di(metha)acrylate, neopentylglycol diglycidyl ether di(metha)acrylate, dipentaerythritol hexa(metha)acrylate, tricyclodecanyl(metha)acrylate, ester acrylate, (metha)acrylic ester of methyrolated melamine, epoxy(metha)acrylate, urethane acrylate, etc.; (metha)acrylic acid; styrene; vinyl acetate; hydroxyethylvinyl ether; ethyleneglycol divinyl ether; pentaerythritol trivinyl ether; (metha)acryl amide; N-hydroxymethyl(metha)acryl amide; N-vinyl formamide; acrylonitrile; etc.

These compounds can be employed either singly or as a mixture of two or more kinds thereof.

If a color composition is desired to be cured through the irradiation of radiation, a photo-polymerization initiator may be added to the color composition. As for the photo-polymerization initiator which is useful in this case, it is possible to employ an acetophenone compound such as 4-phenoxy dichloroacetophenone, 4-t-butyl-dichloroacetophenone, diethoxyacetophenone, 1-(4-isopropylphenyl)-2-hydroxy-2-methylpropan-1-one, 1-hydroxycyclohexylphenyl ketone, 2-benzyl-2-diamino-1-(4-morpholinophenyl)-butan-1-one; a benzoin compound such as benzoin, benzoin methyl ether, benzoin ethyl ether, benzoin isopropyl ether, benzyldimethyl ketal, etc.; a benzophenone compound such as benzophenone, benzoylbenzoic acid, benzoylmethyl benzoate, 4-phenyl benzophenone, hydroxybenzophenone, acrylated benzophenone, 4-benzoyl-4′-methyldiphenyl sulfide, 3,3′,4,4′-tetra(t-butyl peroxycarbonyl)benzophenone, etc.; a thioxanthone compound such as thioxanthone, 2-chlorothioxanthone, 2-methylthioxanthone, isopropylthioxanthone, 2,4-diisopropylthioxanthone, 2,4-diethylthioxanthone, etc.; a triazine compound such as 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2,4-trichloromethyl-(piperonyl)-6-triazine, 2,4-trichloromethyl(4′-methoxystyryl)-6-triazine, etc.; an oxime ester compound such as 1,2-octadione, 1-[4-(phenylthio)-2-(O-benzoyl oxime)], O-(acetyl)-N-(1-phenyl-2-oxo-2-(4′-methoxy-naphthyl)ethylidene)hydroxyl amine, etc.; a phosphine compound such as bis(2,4,6-trimethylbenzoyl)phenyl phosphine oxide, 2,4,6-trimethylbenzoyldiphenyl phosphine oxide, etc.; a quinone compound such as 9,10-phenanthrene quinone, camphor quinine, ethylanthraquinone, etc.; a borate compound; a carbazole compound; an imidazole compound; a titanocene compound; etc.

These photo-polymerization initiators can be employed singly or in combination of two or more kinds. The mixing ratio of these photo-polymerization initiators may preferably be confined within the range of 0.5 to 50% by weight, more preferably 3 to 30% by weight based on a total quantity of the solid matters in the color composition.

The color composition may further comprise a sensitizer, examples of which including an amine-based compound such as triethanol amine, methyldiethanol amine, triisopropanol amine, 4-dimethylamino methylbenzoate, 4-dimethylamino ethylbenzoate, 4-dimethylamino isoamylbenzoate, benzoic acid 2-dimethylamino ethyl, 4-dimethylamino benzoic acid 2-ethylhexyl, N,N-dimethylparatoluidine, 4,4′-bis(dimethylamino)benzophenone, 4,4′-bis(diethylamino)benzophenone, 4,4′-bis(ethylmethylamino)benzophenone, etc.

These sensitizers can be employed singly or in combination of two or more kinds. The mixing ratio of these sensitizers may preferably be confined within the range of 0.5 to 60% by weight, more preferably 3 to 40% by weight based on a total quantity of the photo-polymerization initiator and the sensitizer.

The color composition may further comprise a polyfunctional thiol which is capable of acting as a chain-transfer agent. As for this chain-transfer agent, it is possible to employ a compound having two or more thiol groups. Specific examples of such a compound include hexane dithiol, decane dithiol, 1,4-butanediol bisthiopropionate, 1,4-butanediol bisthioglycolate, ethyleneglycol bisthioglycolate, ethyleneglycol bisthiopropionate, trimethylolpropane tristhioglycolate, trimethylolpropane tristhiopropionate, trimethylolpropane tris(3-mercaptobutylate), pentaerythritol tetrakisthiopropionate, trimercaptopropionate tris(2-hydroxyethyl)isocyanulate, 1,4-dimethylmercaptobenzene, 2,4,6-trimercapto-s-triazine, 2-(N,N-dibutylamino)-4,6-dimercapto-s-triazine, etc.

These polyfunctional thiols can be employed singly or in combination of two or more kinds. The mixing ratio of these polyfunctional thiols may preferably be confined within the range of 0.1 to 30% by weight, more preferably 1 to 20% by weight based on a total quantity of the solid matters in the color composition. If the mixing ratio of these polyfunctional thiols is less than 0.1% by weight, the effected expected from the polyfunctional thiols would become insufficient. On the other hand, if the mixing ratio of these polyfunctional thiols exceeds over 30% by weight, the sensitivity of the color composition would become too high, thereby degrading the resolution on the contrary.

If required, the color composition may further comprise an organic solvent. As for this organic solvent, it is possible to employ, for example, cyclohexanone, ethyl Cellosolve acetate, butyl Cellosolve acetate, 1-methoxy-2-propyl acetate, diethyleneglycol dimethyl ether, ethyl benzene, ethyleneglycol diethyl ether, xylene, ethyl Cellosolve, methyl-n amyl ketone, propyleneglycol monomethyl ether toluene, methylethyl ketone, ethyl acetate, methanol, ethanol, isopropyl alcohol, butanol, isobutyl ketone, petroleum solvent, etc. These organic solvents may be employed singly or in combination of two or more kinds.

If required, the color composition may further comprise a surfactant. As for this surfactant, it is possible to employ an anionic surfactant such as sodium lauryl sulfate, polyoxyethylenealkyl ether sulfate, dodecylbenzene sodium sulfonate, alkali salts of styrene-acrylic acid copolymer, sodium stearate, alkylnaphthaline sodium sulfonate, alkyldiphenyl ether sodium disulfonate, monoethanol amine lauryl sulfate, triethanol amine lauryl sulfate, ammonium lauryl sulfate, monoethanol amine stearate, sodium stearate, sodium lauryl sulfate, monoethanol amine of styrene-acrylic acid copolymer, polyoxyethylene alkylether phosphate, etc.; a nonionic surfactant such as polyoxyethylene oleyl ether, polyoxyethylene lauryl ether, polyoxyethylene nonylphenyl ether, polyoxyethylene alkylether phosphate, polyoxyethylene sorbitan monostearate, polyethyleneglycol monolaurate, polyether-modified dimethylpolysiloxane, polyester-modified polymethylalkylsiloxane, polyether-modified polymethylalkylsiloxane, aralkyl-modified polymethylalkylsiloxane, etc.; cationic surfactant such as alkyl quaternary ammonium salt and an ethylene oxide adduct thereof, etc.; and an amphoteric surfactant such as alkyl betaine such as betaine alkyldimethyl aminoacetate, alkylimidazoline, etc. These surfactants can be employed singly or in combination of two or more kinds.

Then, a photosensitive color composition comprising any of these components is coated on the surface of transparent substrate and then pre-baked. As for the means for coating the color composition, although it is usually possible to employ a spin coating method, a dip coating method or a die coating method, there is not any particular limitation as long as the color composition can be formed in a uniform thickness on an area of substrate of 40-60 cm square. The pre-baking may preferably be performed at a temperature of 50-120° C. for 10-20 minutes. Although the thickness of the coated film can be optionally selected, it may generally be about 2 μm after the pre-baking when the spectral transmittance is taken into consideration.

Then, the photosensitive color composition layer formed on the substrate is subjected to exposure through a patterning mask. As for the light source, it is possible to employ an ordinary high-pressure mercury lamp.

Subsequently, the photosensitive-color composition layer thus exposed is subjected to developing treatment. As for the developing solution, an alkaline aqueous solution can be employed. As for examples of the alkaline aqueous solution, it is possible to employ an aqueous solution of sodium carbonate, an aqueous solution of sodium hydrogencarbonate, a mixed aqueous solution of these materials, or any of these aqueous solutions which additionally contain a suitable surfactant. After the developing treatment, the developed layer is washed with water and dried to obtain a color layer of desired single color.

A sequence of steps described above is repeated required number of times while changing the kind of the photosensitive color composition and the pattern of mask, thus obtaining pixels where colored layers of various colors as required are appropriately combined.

### EXAMPLES

Next, the present invention will be explained in detail with reference to specific examples, which are not intended to limit the scope of the present invention as long as the gist of the present invention is deviated. Incidentally, the contents of components appearing below are all based on weight parts.

[Preparation of Color Compositions]

Red, blue and green color compositions were prepared according to the following procedures.

Red Color Composition:

A mixture comprising the following composition was uniformly stirred and mixed together to obtain a mixture. Then, by making use of glass beads each having a diameter of 1 mm, the mixture was dispersed in a sand mill for five hours and then subjected to filtering using a 5 μm filter to prepare a red pigment dispersion.

Red pigment: C.I. Pigment Red 254

(Irgarfor Red B-CF; Chiba Speciality Chemicals Co., Ltd.)—18 parts

Red pigment: C.I. Pigment Red 177

(Chromophthal Red A2B; Ciba Speciality Chemicals Co., Ltd.)—2 parts

Dispersant (Azispar PB821; Azinomoto Fine Techno Co., Ltd.)—2 parts

Acrylic vanish (solid matters: 20%)—108 parts

Thereafter, a mixture having the following composition is stirred and mixed together to form a homogenous mixture, which was then subjected to filtering using a 5 μm filter to prepare a red color composition.

The dispersant obtained above—130 parts

Trimethylol propane triacrylate—13 parts

(NK Ester ATMPT; Shin Nakamura Kagaku Co., Ltd.)

Photo-initiator (Irgar Cure 907; Ciba-Geigy Co., Ltd.)—3 parts

Sensitizer (EAB-F; Hodogaya Chemicals Co.)—1 part

Cyclohexanone—253 parts

Surfactant (BYK-341; Big Chemie Co., Ltd.)—0.02 parts

Blue Color Composition:

A mixture comprising the following composition was uniformly stirred and mixed together to obtain a mixture. Then, by making use of glass beads each having a diameter of 1 mm, the mixture was dispersed in a sand mill for five hours and then subjected to filtering using a 5 μm filter to prepare a blue pigment dispersion.

Blue pigment: C.I. Pigment Blue 15

(Lionol Blue ES; Toyo Ink Manufacturing Co., Ltd.)—50 parts

Purple pigment: C.I. Pigment Violet 23

(Paliogen Violet 5890; BASF Co., Ltd.)—2 parts

Dispersant (Solsverse 20000; Zenega Co., Ltd.)—6 parts

Acrylic vanish (solid matters: 20%)—200 parts

Thereafter, a mixture having the following composition is stirred and mixed together to form a homogenous mixture, which was then subjected to filtering using a 5 μm filter to prepare a blue color composition.

The dispersant obtained above—268 parts

Trimethylol propane triacrylate—19 parts

(NK Ester ATMPT; Shin Nakamura Kagaku Co., Ltd.)

Photo-initiator (Irgar Cure 907; Ciba-Geigy Co., Ltd.)—4 parts

Sensitizer (EAB-F; Hodogaya Chemicals Co.)—2 part

Cyclohexanone—214 parts

Surfactant (BYK-341; Big Chemie Co., Ltd.)—0.035 parts

Green Color Composition 1:

A mixture comprising the following composition was uniformly stirred and mixed together to obtain a mixture. Then, by making use of glass beads each having a diameter of 1 mm, the mixture was dispersed in a sand mill for five hours and then subjected to filtering using a 5 μm filter to prepare a green pigment dispersion.

Green pigment: C.I. Pigment Green 36

(Lionol Green 6YK; Toyo Ink Manufacturing Co., Ltd.)—16 parts

Yellow pigment: C.I. Pigment Yellow 150

(Fanchion Fast Yellow Y-5688; Bayer Co., Ltd.)—8 parts

Dispersant (Disperbyk-163; Bickchemie Co., Ltd.)—2 parts

Acrylic vanish (solid matters: 20%)—102 parts

Thereafter, by making use of 128 parts of the dispersant described above, a mixture having the following composition is stirred and mixed together to form a homogenous mixture, which was then subjected to filtering using a 5 μm filter to prepare a green color composition.

Trimethylol propane triacrylate—14 parts

(NK Ester ATMPT; Shin Nakamura Kagaku Co., Ltd.)

Photo-initiator (Irgar Cure 907; Ciba-Geigy Co., Ltd.)—4 parts

Sensitizer (EAB-F; Hodogaya Chemicals Co.)—2 part

Cyclohexanone—257 parts

Surfactant (BYK-341; Big Chemie Co., Ltd.)—0.028 parts

Green Color Composition 2:

A green color composition 2 was prepared in the same manner as employed in the manufacture of the green color composition 1 except that 122 parts of a green pigment dispersant prepared according to the following composition ratio was employed.

Green pigment: C.I. Pigment Green 36—12 parts

Yellow pigment: C.I. Pigment Yellow 150—6 parts

Dispersant (Disperbyk-163; Bickchemie Co., Ltd.)—2 parts

Acrylic vanish (solid matters: 20%)—102 parts

Green Color Composition 3:

One part by weight of C.I. Pigment Green 36 (Lionol Blue ES; Toyo Ink Manufacturing Co., Ltd.) was dispersed in 100 parts by weight of pure water and stirred for 6 hours. Thereafter, the resultant mixture was filtered and washed to obtain a green pigment. A green color composition 3 was prepared in the same manner as employed in the manufacture of the green color composition 1 except that 142 parts of a green pigment dispersant prepared according to the following formulation was employed.

Green pigment: C.I. Pigment Green 36—24 parts

Yellow pigment: C.I. Pigment Yellow 150—12 parts

Dispersant (Disperbyk-163; Bickchemie Co., Ltd.)—4 parts

Acrylic vanish (solid matters: 20%)—102 parts

Green Color Composition 4:

A green color composition 4 was prepared in the same manner as employed--in the manufacture of the green color composition 1 except that 155 parts of a green pigment dispersant prepared according to the following composition ratio was employed.

Green pigment: C.I. Pigment Green 36—32 parts

Yellow pigment: C.I. Pigment Yellow 150—16 parts

Dispersant (Disperbyk-163; Bickchemie Co., Ltd.)—5 parts

Acrylic vanish (solid matters: 20%)—102 parts

Green Color Composition 5:

A green color composition 5 was prepared in the same manner as employed in the manufacture of the green color composition 1 except that 168 parts of a green pigment dispersant prepared according to the following formulation was employed.

Green pigment: C.I. Pigment Green 36—40 parts

Yellow pigment: C.I. Pigment Yellow 150—20 parts

Dispersant (Disperbyk-163; Bickchemie Co., Ltd.)—6 parts

Acrylic vanish (solid matters: 20%)—102 parts

[Preparation of Color Filter]

By making use of the red color composition, the blue color composition and the green color composition thus obtained, a color filter was prepared according to the following procedures. As for the green color composition, the aforementioned green color compositions 1 to 5 were respectively employed to prepare the color filters of Examples 1 to 3 and Comparative Examples 1 and 2.

First of all, the red color composition was coated on the surface of a glass substrate by means of spin coating to obtain a film having a thickness of 2 μm. After being dried, the film was subjected to a stripe-shaped patterning exposure by means of an exposure machine and then to a developing treatment for 90 seconds by making use of an alkaline developing solution, thus forming a stripe-shaped red color layer on the surface of transparent substrate. Incidentally, the alkaline developing solution was formulated as follows. In the following examples and comparative examples, this alkaline developing solution was employed to perform the development.

Sodium carbonate—1.5% by weight

Sodium hydrogencarbonate—0.5% by weight

Anionic surfactant—8.0% by weight (Perilex NBL; Kao Corp.)

Water—90% by weight

Next, in the same manner as described above, the green color composition was coated on the surface of a glass substrate by means of spin coating to obtain a film having a thickness of 2 μm. After being dried, by means of an exposure machine, the film was subjected to a stripe-shaped patterning exposure at a location which was displaced from the location where the red color layer was formed. Then, the film was subjected to a developing treatment to form a stripe-shaped green color layer neighboring to the red color layer.

Further, in the entirely same manner as in the cases of red and green color layer, the blue color composition was coated to form a blue color layer having a thickness of 2 μm and neighboring to the red color layer and to the green color layer. As a result, it was possible to obtain a color filter having pixels constituted by stripe-like color layers of three colors, i.e. red, green and blue, on the transparent substrate.

The components of the green color compositions 1 to 5 employed in the preparation of the color films are shown in the following Table 1. For the purpose of comparison, the concentrations of the green pigment relative to the solid matters in the color layers of the color filters of Examples 1 to 3 and Comparative Examples 1 and 2 are shown in the following Table 2.

TABLE 1

| Green color | | Green | Yellow | | Acrylic | Polymerizable | Photo- | | | Total |
|---|---|---|---|---|---|---|---|---|---|---|
| composition | Washing | pigment | pigment | Dispersant | vanish | monomer | initiator | Sensitizer | Solvent | (parts) |
| 1 | None | 16 | 8 | 2 | 102 | 14 | 4 | 2 | 257 | 405 |
| 2 | None | 12 | 6 | 2 | 102 | 14 | 4 | 2 | 257 | 399 |
| 3 | Yes | 24 | 12 | 4 | 102 | 14 | 4 | 2 | 257 | 419 |
| 4 | None | 32 | 16 | 5 | 102 | 14 | 4 | 2 | 257 | 432 |
| 5 | None | 40 | 20 | 6 | 102 | 14 | 4 | 2 | 257 | 445 |

TABLE 2

| | Green color | | Conc. of green |
|---|---|---|---|
| | composition | Washing | pigment (wt %) |
| Ex. 1 | 1 | None | 24.1 |
| Ex. 2 | 2 | None | 19.9 |
| Ex. 3 | 3 | Yes | 29.9 |
| Comp. Ex. 1 | 4 | None | 34.3 |
| Comp. Ex. 2 | 5 | None | 37.6 |

In Example 1, the ratio of green pigment (Pigment Green 36) was 24.1% based on the solid matters; in Example 2, the ratio of green pigment was 19.9%; in Example 3, the ratio of green pigment was 29.9%; in Comparative Example 1, the ratio of green pigment was 34.3%; and in Comparative Example 2, the ratio of green pigment was 37.6%.

Further, the green pigment (Pigment Green 36) which was employed in Example 3 and undergone washing treatment in advance was subjected to boiling in pure water for 3 hours to examine the elution of ions. Likewise, the green pigment (Pigment Green 36) which was employed in each of Examples 1 and 2, and in Comparative Examples 1 and 2 and was not undergone washing treatment in advance was subjected to boiling in pure water for 3 hours to examine the elution of ions. The quantity of ions which were eluted in each of these boiling tests is shown in Table 3 by a value as calculated based on the weight of the pigment. The green pigment (Pigment Green 36) which was employed in Example 3 and undergone washing treatment in advance was found as having enhanced purity.

TABLE 3

Quantify eluted on boiling of
pure water (based on pigment ppm)

| | Ex. 3 | Ex. 1, 2, Comp. Ex. |
|---|---|---|
| Ion | (with washing | (without washing |
| species | treatment) | treatment) |
| Na+ | <2.0 | 13 |
| K+ | <2.0 | 4.0 |
| Cl− | <2.0 | 14 |
| Br− | <2.0 | 5.0 |

FIG. 5 shows a graph wherein dielectric loss tangent is plotted relative to the concentration of green pigment in the solid matters in the color layer. The values of dielectric loss tangent represent those obtained as measured at a frequency of 20 Hz as a representative value.

As seen from the results shown in FIG. 5, the values of dielectric loss tangent depend largely on the concentration of pigment. Thus, when the concentration of the green pigment which was not undergone washing treatment was increased to more than 30% by weight, the dielectric loss tangent was caused to increase to well over 0.03. When the concentration of the green pigment was lowered to about 20% by weight, it was possible to confine the value of dielectric loss tangent to about 0.02. Whereas, in the case of the green pigment which was washed in advance, even if the concentration of the green pigment was increased to 30% by weight or so, it was possible to confine the dielectric loss tangent to about 0.025.

Various kinds of liquid crystal display devices of in-plane switching mode were respectively manufactured by incorporating each of the color filters of Examples. 1, 2 and 3 and the color filters of Comparative Examples 1 and 2. In the cases of the liquid crystal display devices where the color filters of Examples 1, 2 and 3 were incorporated, it was possible to obtain excellent display qualities without accompanying the generation of defective orientation of liquid crystal in the pixels or the generation of deviation in threshold value of driving voltage. Whereas, in the cases of the liquid crystal display devices where the color filters of Comparative Examples 1 and 2 were incorporated, the defective orientation of liquid crystal was caused to generate in the pixels or a phenomenon of seize due to deviations in threshold value of the driving voltage was caused to generate in the liquid crystal display devices, thus failing to obtain excellent display qualities.

What is claimed is:

1. A color filter adapted to be employed in an in-plane switching mode liquid crystal display device, which is incorporated in the liquid crystal display device without interposing electrodes-between a liquid crystal and pixels, and which comprises a transparent substrate, and pixels including color layers representing a plurality of colors and formed on the transparent substrate, wherein a protective layer is not formed on the pixels, and a dielectric loss tangent (tan δ) of at least one color layer is confined to not higher than 0.03 at a frequency ranging from 10 Hz to 100 Hz.

2. The color filter according to claim 1, wherein the pixels comprise a green color layer whose dielectric loss tangent (tan δ) is confined to 0.03 or less at a frequency ranging from 10 Hz to 100 Hz.

3. The color filter according to claim 2, wherein the pixels comprise a red color layer and a blue color layer, the dielectric loss tangent (tan δ) of which is respectively confined to 0.03 or less at a frequency ranging from 10 Hz to 100 Hz.

4. The color filter according to claim 2, wherein the green color layer has a relative dielectric constant of not higher than 5.0 at a frequency ranging from 10 Hz to 100 Hz.

5. The color filter according to claim 1, which has a surface step height of 0.3 μm or less.

6. The color filter according to claim 1, which has a surface in which a contact angle to water is limited to not more than 65°.

7. The color filter according to claim 1, wherein each of the color layers representing a plurality of colors contains a surfactant at a ratio of 0.001 to 0.2% by weight based on the weight of a coating material for forming color layers.

8. The color filter according to claim 2, wherein the green color layer contains a green pigment at a ratio of not more than 30% by weight based on the weight of entire solid matters.

9. The color filter according to claim 1, wherein the green color layer contains a green pigment where a quantity of elution of an alkali metal ion of Na⁺ or K⁺, and of a halogen ion of Cl⁻ or Br⁻ is respectively limited to not higher than 2 ppm in a 3-hour elution test in pure water.

10. A color filter which is adapted to be employed in a liquid crystal display device of in-plane switching mode, which comprises a transparent substrate, and pixels including color layers representing a plurality of colors and formed on the transparent substrate, wherein a difference in dielectric loss tangent (tan δ) between at least one color layer and a liquid crystal material of the liquid crystal display device is confined to not higher than 0.03 at a frequency ranging from 10 Hz to 100 Hz.

11. A liquid crystal display device of in-plane switching mode, which is equipped with any one of the color filters set forth in claim 1.
